(19) United States
(12) Patent Application Publication
(10) Pub. No.: US 2013/0187018 A1
(43) Pub. Date: Jul. 25, 2013

(54) BANNER BRACKET

(71) Applicants: Randy L. Canfield, Traverse City, MI (US); Rick Flees, Grawn, MI (US); Fred Sorensen, Traverse City, MI (US)

(72) Inventors: Randy L. Canfield, Traverse City, MI (US); Rick Flees, Grawn, MI (US); Fred Sorensen, Traverse City, MI (US)

(21) Appl. No.: 13/557,263

(22) Filed: Jul. 25, 2012

Related U.S. Application Data
(60) Provisional application No. 61/574,107, filed on Jul. 28, 2011.

(51) Int. Cl. F16M 13/02

(52) U.S. Cl. CPC F16M 13/02
USPC 248/219.4; 248/251

(57) ABSTRACT

A bracket assembly for holding an article has a base having a rod receiving section that receives a rod assembly including a rod to which an article can be hung. The rod receiving section includes a hollow housing in which a spring and actuator are disposed. A sidewall of the housing has an opening including opposed slots that extend upwardly and away from each other from a junction where lower ends of the slots meet. An inner section of the rod assembly extends through the opening in the sidewall of the housing and is secured to the actuator. Upon the rod deflecting in response to wind loading of the article, the inner section of the rod assembly moves upwardly in one of the slots and translates the actuator upwardly compressing the spring. The compressed spring urges the actuator downwardly to return the actuator to a neutral position.

### CROSS-REFERENCE TO RELATED APPLICATIONS

This application claims the benefit of U.S. Provisional Application No. 61/574,107 filed Jul. 28, 2011. The entire disclosure of the above application is incorporated herein by reference.

### FIELD

The present invention relates to brackets for holding articles such as banners, and more particularly, to a bracket that attaches to a vertical pole and reduces moment leverage caused by wind.

### BACKGROUND

It is common to suspend articles such as banners from vertical poles located outdoors, such as street poles, light poles, and the like. To do so, a horizontal arm, which may be steel or fiberglass rods, is secured to the pole and extends horizontally outwardly therefrom. The article is hung from the arm. Multiple horizontal arms may be used and the article secured to each. For example, an upper arm and a lower arm may be used to suspend a banner with the banner stretched between the two arms.

Wind will exert forces on the article, which will be referred to herein as wind loading. As the velocity of the wind increases, so does the wind loading. Wind gusts will cause sudden increases in the wind loading. The wind loading, particularly the sudden increases in wind loading caused by wind gusts, can prove destructive to the articles, particularly banners and the poles. There have been different approaches utilized to reduce the destructive effect of wind loading, such as those described in U.S. Pat. No. 5,388,794. For example, as described in the Background section of U.S. Pat. No. 5,388,794, the arm (or arms) can be mounted in a base plate that is held onto a bracket base by means of a spring. The arrangement of planar surfaces of the base plate and bracket base and the spring allows a limited movement of the base plate receiving the arm. Also as described in U.S. Pat. No. 5,388,794, a pair of base plates are fixed in spaced relation on a vertical post. The base plates each have a pair of grooves extending longitudinally to the post adjacent side edges of the base plate and a pair of swing plates having a pair of longitudinally extending lips that rest normally in pairs of grooves in the base plates and each has means for fixing a banner supporting rod in the swing plate wherein the swing plates and the rods may be pivoted with respect to the base plate. A spring between each of the swing plates and its respective base plate restrains the swinging movement of the swing plate and its rod.

### BRIEF DESCRIPTION OF THE DRAWINGS

The present invention will become more fully understood from the detailed description and the accompanying drawings, wherein:

FIG. 1 is an exploded view of a bracket assembly in accordance with an aspect of the present disclosure;

FIG. 2 is top view of the bracket assembly of FIG. 1;

FIG. 3 is a side section view taken along the lines of 3-3 in FIG. 2;

FIG. 4 is a front view of the bracket assembly of FIG. 1; and

FIG. 5 is a rear view of the bracket assembly of FIG. 4.

### SUMMARY

In accordance with an aspect of the present disclosure, a bracket assembly for holding an article has a base having a rod receiving section that receives a rod assembly including a rod to which an article can be hung. The rod receiving section includes a hollow housing in which a spring and actuator are disposed. The actuator is translatable axially therein. A sidewall of the housing has an opening including opposed slots that extend upwardly and away from each other from a junction where lower ends of the slots meet. An inner section of the rod assembly extends through the opening in the sidewall of the housing and is secured to the actuator. Upon the rod deflecting in response to wind loading of the article hung to the rod, the inner section of the rod assembly moves upwardly in one of the slots and translates the actuator upwardly compressing the spring. The compressed spring urges the actuator downwardly to return the actuator to a neutral position as wind load reduces and force exerted by the compressed spring overcomes the reduced wind load.

In an aspect, the slots are curved. In an aspect, the slots are each segments of a helix.

In an aspect, the housing is a cylindrical housing. In an aspect, the actuator is rotatable in the housing and the inner section of the rod assembly also rotates the actuator as the inner section of the rod assembly moves upwardly in one of the slots.

In an aspect, the rod assembly includes a rod adapter having an outer section that receives the rod and an inner section that comprises the inner section of the rod assembly.

In an aspect, a thrust bearing is disposed between a bottom of the spring and the actuator.

In an aspect, the rod assembly includes a coupler having an outer section having a hollow bore that receives the rod and an inner collar surrounding an outer section of the rod adapter.

In an aspect, the actuator includes a lower portion having a bore in which an inner section a rod adapter is received and an upper portion having a recess in which a lower portion of the spring is received with the thrust bearing disposed between the bottom of the spring and a bottom of the recess.

In an aspect, the base includes a mounting section having a surface for mating against a pole when the bracket assembly is secured to the pole. In an aspect, the surface of the mounting section for mating against the pole is a concave surface.

### DETAILED DESCRIPTION

The following description of the preferred embodiment(s) is merely exemplary in nature and is in no way intended to limit the invention, its application, or uses.

With reference to the Figures, a bracket assembly 100 for suspending an article such as a banner from a pole in accordance with an aspect of the present disclosure is shown. Bracket assembly 100 includes a base 102 having a mounting section 104 for securing bracket assembly 100 to a pole 106, which is typically a vertical pole and typically cylindrical or at least quasi-cylindrical. Mounting section 104 includes a concave side 108 for mating against pole 106 when bracket assembly 100 is secured to pole 106. Base 102 also includes a rod receiving section 110. Illustratively, rod receiving section 110 has a hollow cylindrical housing 111 that extends outwardly from pole mounting section 104 from a side opposite to concave surface 108. For reference purposes, the side of base closest to pole 106 when bracket assembly 100 is secured to pole 106 will be considered the inner side of base 102. Concave side 108 of mounting section 104 is thus at the inner side of base 102. Rod receiving section 110 receives a rod assembly 112 that includes a rod 113 to which an article such as a banner 114 can be hung.

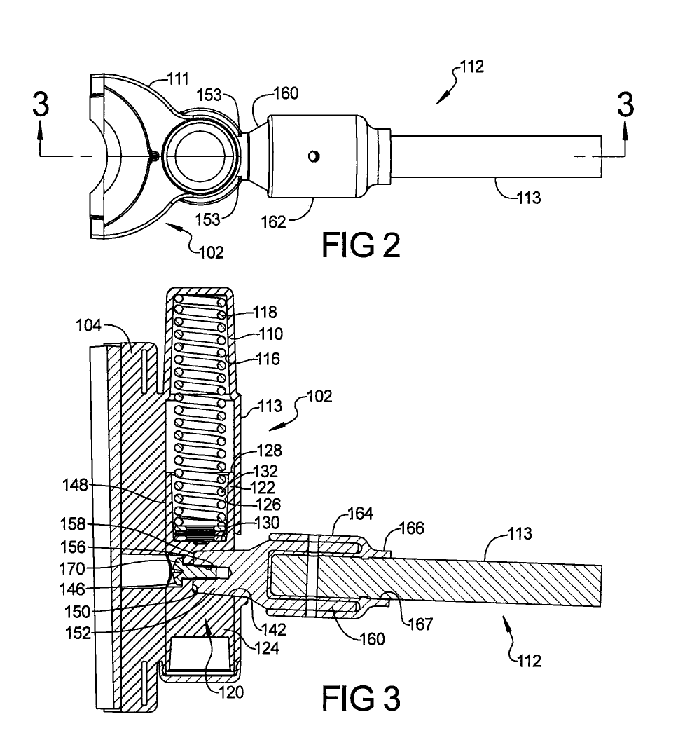

Hollow cylindrical housing 111 of rod receiving section 110 defines therein an axially extending hollow cylinder 116 (best shown in FIG. 2). A spring 118 is disposed in hollow cylinder 116. Spring 118 may illustratively be a compression spring. An actuator 120 is also disposed in hollow cylinder 116. Actuator 120 includes an upper portion 122 and a lower portion 124. Upper portion 122 includes a recess 126 (FIG. 3) opening at a top 128 of upper portion 122. A bottom 130 of upper portion 122 is closed (or partially closed) defining a bottom of recess 126. Recess 126 may for example be a hollow cylinder, cup shaped, or the like. A lower portion 132 of spring 118 is received in recess 126 of upper portion 122 of actuator 120 with a thrust bearing 134 disposed between a bottom 136 of spring 118 and bottom 130 of upper portion 122. Thrust bearing 134 may illustratively be a roller thrust bearing. It should be understood that it can be other types of thrust bearings. Washers 138 may be disposed on either side of thrust bearing 134. Actuator 120 is rotatably received in hollow cylinder 116. A cap 121 is affixed to the bottom of hollow cylindrical housing 111. Cap 121 may be a removable cap, such as a threaded cap, or it may be permanently affixed.

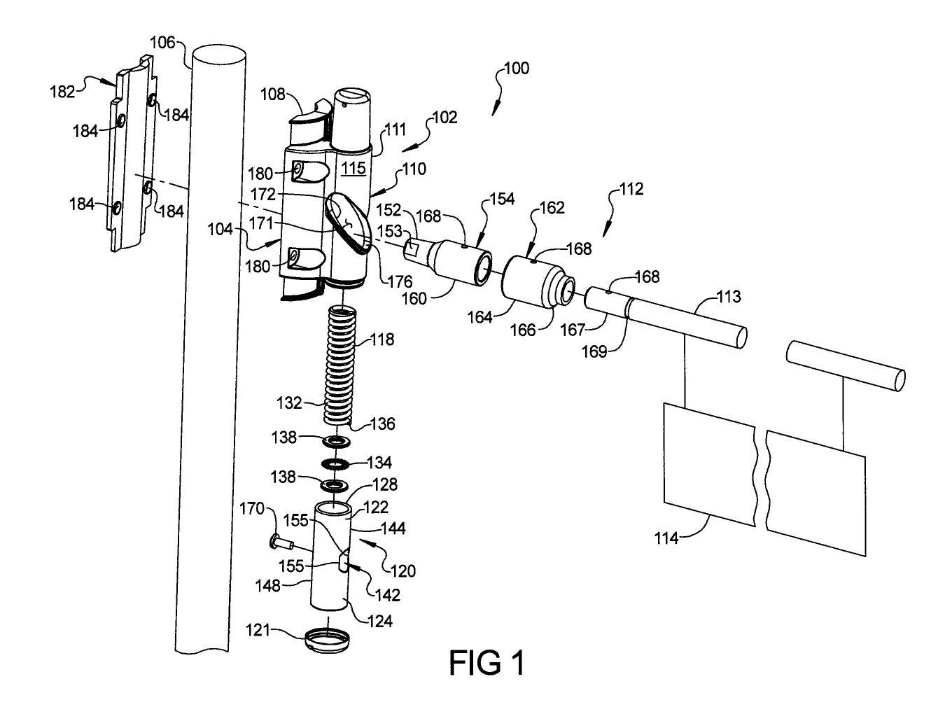

Lower portion 124 of actuator 120 includes a radially extending bore 142 that extends partially into lower portion 124 from an outer side 144 of lower portion 124 and a radially extending screw hole 146 that extends partially through lower portion 124 from an inner side 148 of lower portion 124 to an inner end 150 of bore 142. Bore 142 receives an inner section 152 of rod assembly 112. In the embodiment shown in the drawings, rod assembly 112 includes a rod adapter 154 and a coupler 162. In this embodiment, inner section 152 of rod assembly 154 is an inner section of rod adapter 154. Inner section 152 may illustratively be a tapered rod having a threaded opening 156 in an inner end 158. Inner section 152 may have flats 153 (only one of which is shown in FIG. 1) on opposed sides. Actuator 120 includes flats 155 on opposed sides of bore 142 that correspond to flats 153. Flats 153, 155 prevent rod adapter 154 from rotating when inner section 152 of rod assembly 154 is received in bore 142. Also, actuator 120 has a thicker wall at flats 155 that adds strength. An outer section 160 of rod adapter 154 may be a hollow cylindrical section. The outer sections 160 of different rod adapters 154 may have different diameters to accommodate different sized rods 113. In an aspect, coupler 162 may be utilized to aid in securing rod 113 to rod adapter 154. Coupler 162 may include a hollow inner collar 164 that fits over outer section 160 of rod adapter 154 and an outer section 166 that surrounds an end section 167 of rod 113. Coupler 162 may illustratively be an insert molded plastic part with outer section 166 molded over end section 167 of rod 113 when coupler 162 is molded. End section 167 of rod 113 may include a groove 169 into which plastic is molded when coupler 162 is molded around end section 167 of rod 113. Rod 113, coupler 162 and rod adapter 154 each include a hole 168 for securing rod 113 and coupler 162 to rod adapter 154 with a fastener (not shown), such as a pin. A screw 170 inserted into screw hole 146 is tightened into threaded opening 156 in inner end 158 of rod adapter 154 to secure rod adapter 154 to actuator 120.

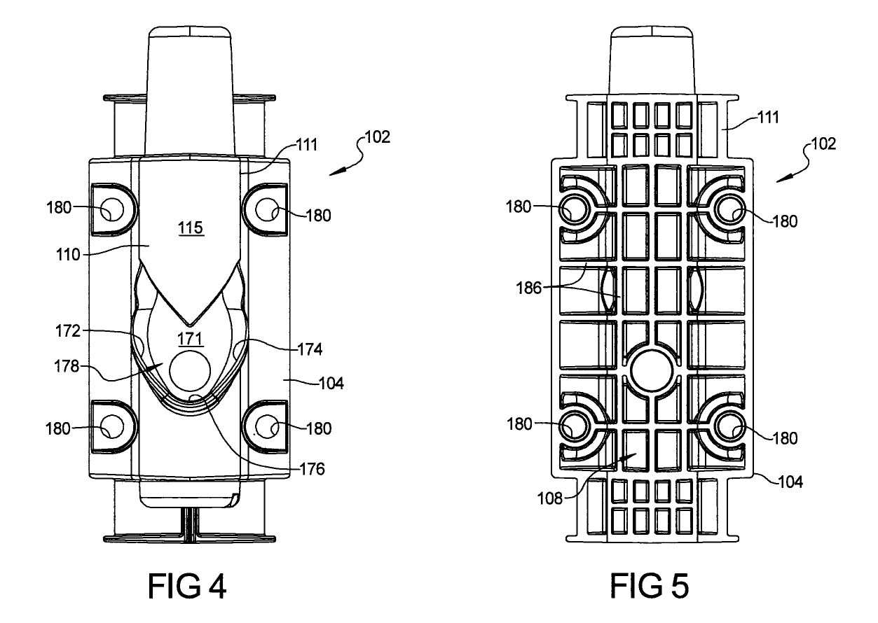

Housing 111 of rod receiving section 110 has a sidewall 115 that includes an opening 171 in which inner section 152 of rod assembly 112 is received. As best shown in FIG. 4, opening 171 illustratively includes opposed slots 172, 174 that extend upwardly and away from each other from a junction 176 where lower ends of the slots 172, 174 meet. Slots 172, 174 may illustratively be curved and curve away from each other as they extend upwardly. Slots 172, 174 may be each be segments of a helix. It should be understood that slots 172, 174 can be other than segments of helix. Slots 172, 174 and junction 176 may be referred to herein as helix 178. Inner section 152 of rod adapter 154 is inserted into helix 178 and secured to actuator 120 as described above.

In an aspect, mounting section 104 may be secured to pole 106 such as with steel banding. In an aspect, mounting section 104 may include screw holes 180. To secure base 102 to pole 106, concave surface 108 of mounting section 104 is placed against pole 106, a backing plate 182 placed on the side of pole 106 opposite mounting section 104, screws (not shown) inserted into screw holes 180 and tightened into corresponding threaded openings 184 in backing plate 182. It should be understood that base 102 can be secured to pole 106 in other ways. For example, U-bolts could be used with the legs of the U-bolts extending into screw holes 180 with the bights of the U-bolts around pole 106. Nuts would then be tightened on threaded ends of the legs of the U-bolts.

Base 102 may be made of metal, such as steel or aluminum, or of plastic. It may for example be a metal cast part or a plastic molded part, such as an injection molded part. Mounting section 104 of base 102 may include reinforcing ribs 186 (best shown FIG. 5), particularly when base 102 is a plastic molded part. In an aspect, a reinforced edge may be provided around the edges of helix 178.

In operation, banner holding bracket will have been mounted to pole 106 as described above and rod adapter 154 will have been secured to actuator 120 as described above. Rod 113 will have been secured to rod adapter 154 as described above, and coupler 162 may have been used in doing so. A banner 114 will have been hung from rod 113. When the wind is calm, rod assembly 112 is in a neutral position where rod adapter 154 is at junction 176 of helix 178. When wind blows, helix 178 allows rod assembly 112 to deflect under load by rod assembly 112 rotating actuator 120. The inner end 152 of rod assembly 112 rides upwardly along one of slots 172, 174 (depending on wind direction) which moves actuator 120 upwardly thus compressing spring 118. Slots 172, 174 may illustratively be sized so that rod assembly 112 can turn actuator 120 ninety degrees in either direction from the neutral position. Spring 118 when compressed, urges actuator 120 downwardly and thus rod assembly 112 back toward the neutral position so that rod assembly 112 will return to the neutral position once the wind load has dropped sufficiently.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A bracket assembly for holding an article, comprising:
a base having a rod receiving section that receives a rod assembly including a rod to which an article can be hung;
the rod receiving section including a hollow housing in which a spring and actuator are disposed, the actuator translatable axially in the housing, a sidewall of the hollow housing having an opening including opposed slots that extend upwardly and away from each other from a junction where lower ends of the slots meet;
an inner section of the rod assembly extending through the opening in the sidewall of the cylindrical housing and secured to the actuator; and
upon the rod deflecting in response to wind loading of the article hung to the rod the inner section of the rod assembly moves upwardly in one of the slots and translates the actuator upwardly compressing the spring wherein the compressed spring urges the actuator downwardly to return the actuator to a neutral position as wind load reduces and force exerted by the compressed spring overcomes the reduced wind load.

2. The bracket assembly of claim 1 wherein the slots are curved.

3. The bracket assembly of claim 2 wherein the slots are each segments of a helix.

4. The bracket assembly of claim 2 wherein the housing is a cylindrical housing.

5. The bracket assembly of claim 4 wherein the actuator is rotatable in the housing and the inner section of the rod assembly also rotates the actuator as the inner section of the rod assembly moves upwardly in one of the slots.

6. The assembly of claim 2 wherein the rod assembly includes a rod adapter having an outer section that receives the rod and an inner section that comprises the inner section of the rod assembly.

7. The bracket assembly of claim 6 including a thrust bearing disposed between a bottom of the spring and the actuator.

8. The bracket assembly of claim 7 wherein the rod assembly includes a coupler having an outer section surrounding an end section of the rod and an inner collar surrounding an outer section of the rod adapter.

9. The bracket assembly of claim 7 wherein the actuator includes a lower portion having a bore in which an inner section a rod adapter is received and an upper portion having a recess in which a lower portion of the spring is received with the thrust bearing disposed between the bottom of the spring and a bottom of the recess.

10. The bracket assembly of claim 1 wherein the base includes a mounting section having a surface for mating against a pole when the bracket assembly is secured to the pole.

11. The bracket assembly of claim 10 wherein the surface of the mounting section for mating against the pole is a concave surface.
